(19) United States
(12) Patent Application Publication
(10) Pub. No.: US 2021/0243252 A1
(43) Pub. Date: Aug. 5, 2021

(54) DIGITAL MEDIA SHARING

(71) Applicant: Lenovo (Singapore) Pte. Ltd., Singapore (SG)

(72) Inventors: Mark Patrick Delaney, Raleigh, NC (US); Nathan J. Peterson, Oxford, NC (US); Russell Speight VanBlon, Raleigh, NC (US); John Carl Mese, Cary, NC (US); Arnold S. Weksler, Raleigh, NC (US)

(21) Appl. No.: 16/780,456

(22) Filed: Feb. 3, 2020

(51) Int. Cl. H04L 29/08; G06K 9/00

(52) U.S. Cl. CPC H04L 67/1044; H04L 67/06; G06K 9/00255; G06K 9/00201; G06K 9/00241

(57) ABSTRACT

One embodiment provides a method, including: capturing, using an information handling device, digital media associated with a user; determining, using a processor, an association between the digital media and at least one other individual; and prompting, based on the determining, the user to share the digital media with the at least one other individual. Other aspects are described and claimed.

### BACKGROUND

Users frequently utilize their information handling devices (“devices”), for example smart phones, tablets, smart speakers, laptop and/or personal computers, and the like, to capture various types of digital media content (e.g., images, videos, audio recordings, etc.). For example, a user may use a front-facing camera on their smart phone to capture a picture of themselves and/or other individuals positioned in close proximity to the user. As another example, a user may use a worldview camera on their smart phone to capture a video of a group of individuals.

### BRIEF SUMMARY

In summary, one aspect provides a method, comprising: capturing, using an information handling device, digital media associated with a user; determining, using a processor, an association between the digital media and at least one other individual; and prompting, based on the determining, the user to share the digital media with the at least one other individual.

Another aspect provides an information handling device, comprising: at least one sensor; a processor; a memory device that stores instructions executable by the processor to: capture digital media associated with a user; determine an association between the digital media and at least one other individual; and prompt, based on the determining, the user to share the digital media with the at least one other individual.

A further aspect provides a product, comprising: a storage device that stores code, the code being executable by a processor and comprising: code that captures digital media associated with a user; code that determines an association between the digital media and at least one other individual; and code that prompts, based on the code that determines, the user to share the digital media with the at least one other individual.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of sharing digital media content.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

After digital media content is captured by a user, individuals that may be associated in some way with that content may request the user to send the content to them (e.g., via text message, social media post, email, BLUETOOTH, cloud sharing, etc.). For example, a user may capture a variety of photos of themselves and/or others at an event (e.g., a wedding, a party, another type of celebration, etc.). During or after the event, the individuals that appeared in the photos may request the user for a copy of the photos they appeared in.

Existing solutions require the user to manually transmit the requested media content to the requesting individual. For example, the user must retrieve contact information for the requesting individual (e.g., stored in a contact list, etc.), insert or attach the media content to a message, and thereafter transmit the message containing the attached media content to the requesting individual. This process may be time-consuming and burdensome. Furthermore, it is not uncommon for users to forget to send the digital media to the requesting individual after the event has finished, which may cause frustration. Additionally or alternatively, the user may be harassed by the requesting individual until the user manually sends them the content. Both of the foregoing situations produce results that are inconvenient to the user.

Accordingly, an embodiment provides a method for dynamically identifying individuals that may be interested in an article of digital media content and thereafter prompting a user to share the media content with them. In an embodiment, digital media content may be captured by a device. An embodiment may thereafter determine an association between the digital media content and at least one other individual. For example, an embodiment may identify that another individual was located proximate to a user when a photo was taken and/or that the other individual was present in the photo. Responsive to determining the association, an embodiment may prompt the user to share the digital media content with the associated individual. Additionally or alternatively, an embodiment may automatically share the digital media content with the associated individual without any additional user notification or input. Such a method may improve the way digital media content is shared by lessening the manual burden on the content capturer and by increasing the likelihood that relevant individuals will receive the digital media content in a timely fashion.

The illustrated example embodiments will be best understood by reference to the figures. The following description is intended only by way of example, and simply illustrates certain example embodiments.

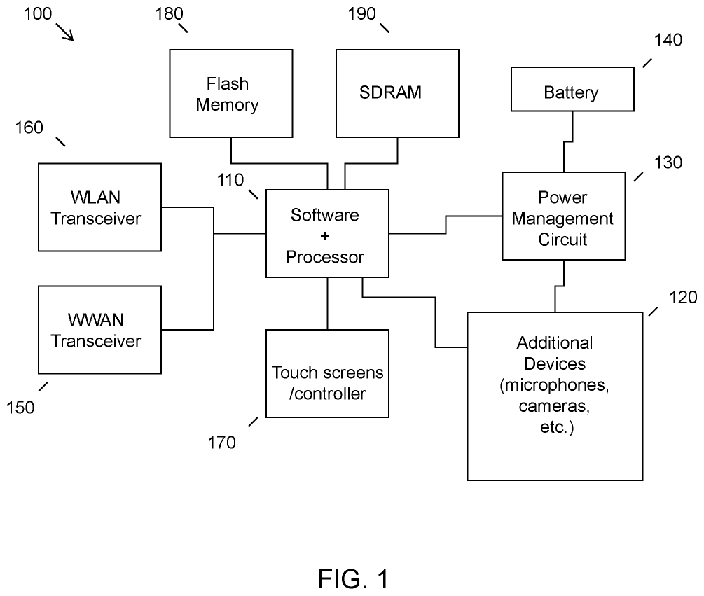

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

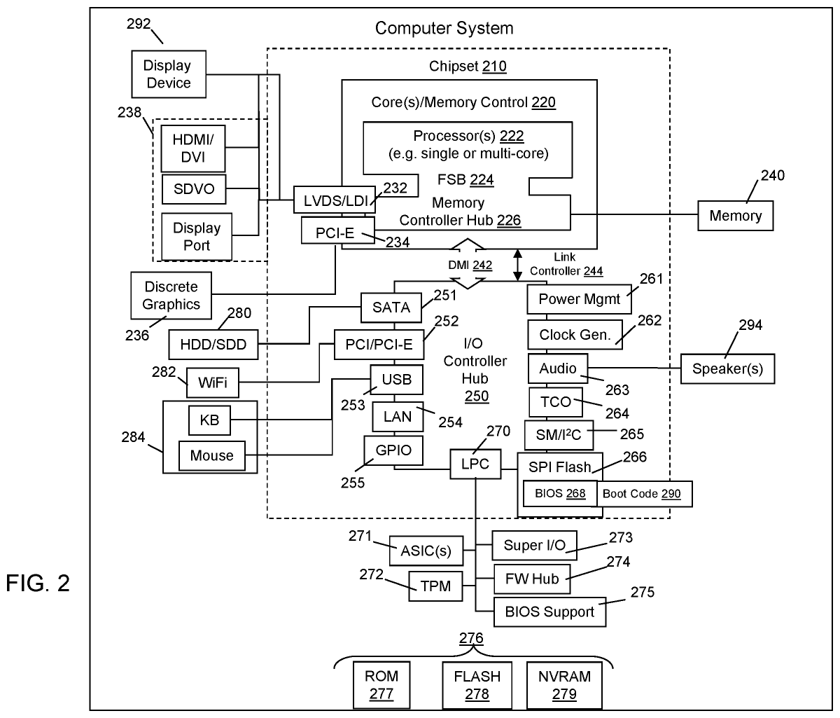

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices capable of capturing and sharing digital media content. For example, the circuitry outlined in FIG. 1 may be implemented in a smart phone or tablet embodiment, whereas the circuitry outlined in FIG. 2 may be implemented in a laptop.

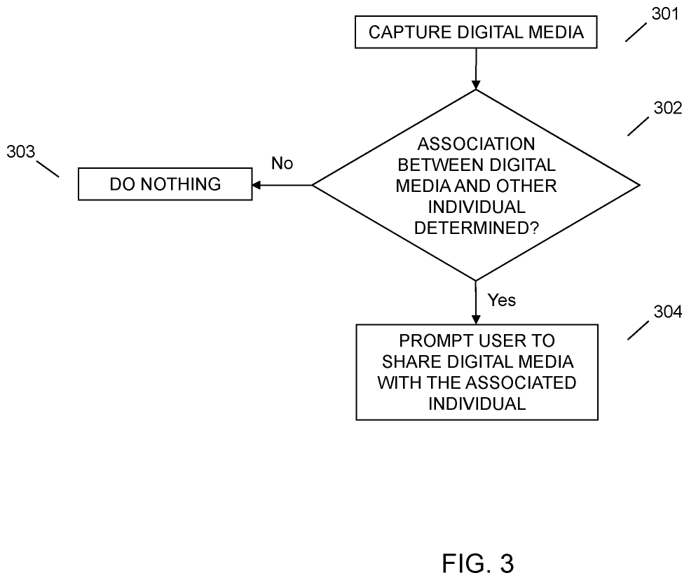

Referring now to FIG. 3, an embodiment provides a method for dynamically identifying and sharing digital media content with relevant individuals. At 301, an embodiment may capture digital media content (“content”). The content may refer to virtually any type of content (e.g., images, videos, audio recordings, a combination of two or more of the foregoing, etc.). In an embodiment, the content may be captured by a content capturing device integrally or operatively coupled to the user's device (e.g., a camera/video sensor, a microphone, etc.). In an embodiment, the content may be associated in some way with the user. For example, the user may be the capturer of the content. Additionally or alternatively, the user may be present in the content (e.g. present in a photo or video, speaking in an audio recording, etc.).

At 302, an embodiment may determine whether an association exists between the content and at least one other individual. In an embodiment, the association may correspond to a proximity association between the user and another individual at a time substantially when the content was captured. Stated differently, an embodiment may determine that an association exists between the content and another individual responsive to identifying that the other individual was proximate to the user when the content was captured or created. In this regard, the proximity determination may be facilitated by identifying that a device associated with the other individual was within a predetermined threshold distance (e.g., 1 foot, 3 feet, 10 feet, etc.) of the content capturing device (e.g., the user's device, etc.) when the content was captured.

In an embodiment, the identity of the proximate individual may be determined using one or more techniques. For example, the user's device may receive a signal from the device associated with the other individual. This signal may comprise identifying information that specifies the identity of the other individual. In another example, the user's device may receive a device identification signal from the device associated with the other individual. An embodiment may then access an accessible storage database (e.g., stored locally on the device, stored remotely in another storage location, etc.) that comprises a list of device identification signals, wherein each of the device identification signals is associated with a particular individual. Thereafter, an embodiment may then determine whether the received device identification signal corresponds to a signal in the list.

In an embodiment, the association may be further confirmed by utilizing data resulting from one or more of the association-confirming processes described below in combination with the proximity determination. It is important to note that the following association-confirming processes are not exhaustive and other processes, not explicitly described here, may also be used to provide confidence to a system that an association between captured content and another individual exists.

In an embodiment, certain types of content (i.e., images and videos) may be subject to conventional facial recognition techniques. These techniques may be utilized to identify facial characteristics of the pictured individuals and thereafter compare those identified characteristics to stored characteristics of known individuals to identify whether a match exists. For example, User A and User B may take a picture together on User A's smart phone. An embodiment may recognize User B through facial recognition and may also recognize that User B was in close proximity to User A at the time the picture was captured. Accordingly, an embodiment may conclude that User B shares a relationship to the picture and likely has some interest in it.

In a similar embodiment to the foregoing, the same types of content (i.e., images and videos) may also be subject to conventional object recognition techniques. More particularly, these techniques may be utilized to determine the identity of pictured objects and determine, by comparing the identified object against an accessible database, whether any of these identified objects share an association with a particular user. For example, User A and User B may take a picture together on User A's phone. User B may be wearing a unique jacket that is recognized by the system of an embodiment (i.e., through one or more object recognition techniques). An embodiment may thereafter attempt to determine whether the identified jacket belongs to any known individual by comparing the jacket against one or more images (e.g., images stored locally or remotely in an image database, images accessed online through a social media platform or website, etc.). Responsive to discovering one or more other images of User B wearing the jacket, an embodiment may receive increased confidence in User B's identity and may utilize this data point, along with User B's proximity information, to conclude that User B likely has an interest in this picture.

In yet another similar embodiment, certain types of content (i.e., videos and audio recordings) may be subject to conventional audio analysis techniques. More particularly, these techniques may be utilized to analyze the characteristics of sounds present in the content and thereafter determine whether these audible characteristics correspond to the audible characteristics of a known individual. For example, User A and User B may both be participating in a recorded conference meeting. An embodiment may be able to detect and analyze the audible input provided by either user during the meeting. Using audio analysis, an embodiment may be able to determine that a voice pattern associated with User B was detected (e.g., by comparing characteristics of the detected audio to a database of associations between audio characteristics and particular individuals, etc.). Utilizing this data point, along with User B's proximity information to User A during the conference meeting, an embodiment may conclude that User B was associated with the audio recording and may have some interest in it.

Another type of association-confirming process that may leverage one or more of the foregoing processes is a relationship recognition process. More particularly, an embodiment may determine that a particular individual shares a relationship (e.g., a familial relationship, etc.) with one or more other individuals that are present in the content. An embodiment may thereafter utilize this relationship to conclude that the particular individual has an interest in the content. For example, User A may take a picture of his son and User B's son. An embodiment may recognize User B's son and the relationship between User B and his son (e.g., by referencing an accessible database of known relationships, by analyzing content in social media posts or communications, etc.). An embodiment may also recognize that User B is in close proximity to User A when the picture was taken. Utilizing the combination of these data points, an embodiment may conclude that User B likely has some interest in this picture.

Responsive to determining, at 302, that no association exists between the content and another individual, an embodiment may, at 303, take no additional action. Conversely, responsive to determining, at 302, that an association does exist between the content and another individual, an embodiment may, at 304, prompt the user to share the digital media content with the other individual.

In an embodiment, the prompt may be a notification that is presented to the user in one or more different formats. For example, the notification may be a visual notification that appears on a display screen of the user's device or on a display screen of another associated device (e.g., a display screen of the user's smart watch that is connected to or is in communication with the user's smart phone, etc.). As another example, the notification may be an audible notification that is output to the user using the user's device or another associated device (e.g., a smart speaker that is connected to or is in communication with the user's smart phone, etc.). In an embodiment, the notification prompt may be presented to the user at substantially the time that an association is determined to exist or, alternatively, a predetermined time period after the association is determined (e.g., 1 minute later, 30 minutes later, 1 hour later, etc.).

In an embodiment, the notification may comprise an indication about the identity of the individuals determined to be associated with the content and/or may comprise a request that queries the user whether they want to transmit the content to these individuals. For example, a non-limiting visual notification that may be presented to the user may be as follows, “John Smith was identified as being in this photo. Do you want to share this photo with John Smith?” Responsive to receiving an affirmative response to the query, an embodiment may thereafter transmit the content to the associated individual.

In an embodiment, a system may transmit the content to the associated individual via any medium for which they have contact information for the associated individual. Additionally or alternatively, in another embodiment, if a plurality of mediums exist for which the system has contact information, a default contact medium may be originally selected by a manufacturer and/or later adjusted by the user. For example, if an embodiment has an associated individual's email address and phone number, a user may designate that all content transmissions to this associated individual be facilitated through text message.

In an embodiment, the prompt to the user may simply be a notification that the content was dynamically shared with an associated individual. Stated differently, an embodiment may forego requesting the user about their intent to share the content and instead automatically share the content responsive to identifying an associated individual. In this situation, an embodiment may only engage in the automatic transmission of content responsive to identifying that a relationship between the user and the associated individual is greater than a predetermined threshold relationship. For example, an embodiment may identify that the associated individual is an individual that the user frequently contacts (e.g., a family member, a close friend, etc.) and that would likely be fine receiving a content transmission from the user.

The various embodiments described herein thus represent a technical improvement to conventional methods of sharing digital media content. Using the techniques described herein, an embodiment may capture digital media associated with a user. An embodiment may then determine whether an association exists between the digital media and at least one other individual (e.g., a proximity association, etc.). Additionally or alternatively, an embodiment may receive increased confidence in the association determination by conducting one or more recognition processes (e.g., facial recognition, object recognition, audio recognition, relationship recognition, etc.) Responsive to determining that an association does exist, an embodiment may prompt the user to share the digital media with the associated individual. Such a method may improve the digital media sharing experience for both the media capturing user and the individual(s) associated with the digital media.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
capturing, using an information handling device, digital media associated with a user;
determining, using a processor, an association between the digital media and at least one other individual, wherein the determining comprises identifying that another user is present in the digital media and that the another user shares a relationship to the at least one other individual; and
prompting, based on the determining, the user to share the digital media with the at least one other individual, wherein the prompting comprises notifying the user that the digital media was automatically shared with the at least one other individual.

2. The method of claim 1, wherein the digital media comprises media selected from the group consisting of an image, a video, and an audio segment.

3. The method of claim 1, wherein the association corresponds to a proximity association between the at least one other individual and the user at a time when the digital media was captured.

4. The method of claim 3, wherein the determining the proximity association comprises identifying that at least one other device associated with the at least one other individual is within a predetermined threshold distance of the information handling device.

5. The method of claim 3, wherein the association is further confirmed utilizing at least one process selected from the group consisting of a facial recognition process, an object recognition process, and a relationship recognition process.

6. The method of claim 5, wherein the at least one process corresponds to the facial recognition process and wherein the determining the association further comprises determining, based on the facial recognition process, that the at least one other individual is present in the digital media.

7. (canceled)

8. The method of claim 5, wherein the at least one process corresponds to the object recognition process and wherein the determining the association further comprises determining, based on the object recognition process, that at least one object associated with the at least one other individual is present in the digital media.

9. The method of claim 1, wherein the prompting comprises automatically sharing the digital media with the at least one other individual.

10. The method of claim 9, wherein the automatically sharing comprises automatically sharing responsive to identifying that a relationship status between the user and the at least one other individual is greater than a predetermined threshold.

11. An information handling device, comprising:
at least one sensor;
a processor;
a memory device that stores instructions executable by the processor to:
capture digital media associated with a user;
determine an association between the digital media and at least one other individual, wherein the determining comprises identifying that another user is present in the digital media and that the another user shares a relationship to the at least one other individual; and
prompt, based on the determining, the user to share the digital media with the at least one other individual, wherein the prompting comprises notifying the user that the digital media was automatically shared with the at least one other individual.

12. The information handling device of claim 11, wherein the digital media comprises media selected from the group consisting of an image, a video, and an audio segment.

13. The information handling device of claim 11, wherein the association corresponds to a proximity association between the at least one other individual and the user at a time when the digital media was captured.

14. The information handling device of claim 13, wherein the instructions executable by the processor to determine the proximity association comprise instructions executable by the processor to identify that at least one other device associated with the at least one other individual is within a predetermined threshold distance of the information handling device.

15. The information handling device of claim 13, wherein the association is further confirmed utilizing at least one process selected from the group consisting of a facial recognition process, an object recognition process, and a relationship recognition process.

16. The information handling device of claim 15, wherein the at least one process corresponds to the facial recognition process and wherein the instructions executable by the processor to determine the association further comprise instructions executable by the processor to determine, based on the facial recognition process, that the at least one other individual is present in the digital media.

17. (canceled)

18. The information handling device of claim 15, wherein the at least one process corresponds to the object recognition process and wherein the instructions executable by the processor to determine the association further comprise instructions executable by the processor to determine, based on the object recognition process, that at least one object associated with the at least one other individual is present in the digital media.

19. The information handling device of claim 11, wherein the instructions executable by the processor to prompt comprise instructions executable by the processor to automatically share the digital media with the at least one other individual.

20. A product, comprising:
a storage device that stores code, the code being executable by a processor and comprising:
code that captures digital media associated with a user;
code that determines an association between the digital media and at least one other individual, wherein the code that determines comprises code that identifies that another user is present in the digital media and that the another user shares a relationship to the at least one other individual; and
code that prompts, based on the code that determines, the user to share the digital media with the at least one other individual, wherein the code that prompts comprises code that notifies the user that the digital media was automatically shared with the at least one other individual.
